(19) United States
(12) Patent Application Publication
(10) Pub. No.: US 2003/0158942 A1
(43) Pub. Date: Aug. 21, 2003

(54) Real-time reconfiguration of computer networks based on system measurements

(75) Inventors: Shahar Frank, Ramat Hasharon (IL); Nir Peleg, Beer Yaacov (IL); Menachem Rosin, Rehovot (IL); Amnon A. Strasser, Tel Aviv (IL)

Correspondence Address: SUGHRUE MION, PLLC, 2100 Pennsylvania Avenue, NW, Washington, DC, 20037-3213, US

(73) Assignee: EXANET, INC.

(21) Appl. No.: 10/201,599

(22) Filed: Jul. 24, 2002

Related U.S. Application Data
(60) Provisional application No. 60/356,736, filed on Feb. 15, 2002.

(51) Int. Cl. G06F 15/173; G06F 15/16; G06F 9/46

(52) U.S. Cl. 709/226; 709/203; 709/330

(57) ABSTRACT

A method for real-time reconfiguration of a computer network using load information from the computer network. The method comprises receiving remote procedure call (RPC) information by a server in the computer network. The RPC information is analyzed. Based on the analysis, it is determined whether a reconfiguration is required. If reconfiguration is required, one or more objects are relocated until reconfiguration is completed.

### RELATED APPLICATIONS

The application claims priority from a co-pending U.S. Provisional Patent Application Serial No. 60/356,736 filed Feb. 15, 2002, the contents of which are incorporated herein by reference. This application is also related to concurrently-filed U.S. patent application entitled “A Method and Computer Software for Real-Time Network Configuration”, [Attorney Docket No. Q68524], and which is assigned to the same common assignee as the present application, and is hereby incorporated herein by reference in its entirety for all it discloses.

### DESCRIPTION

1. Field

The present disclosure teaches reconfiguration of digital computer networks based on measurement of load parameters. More specifically, the disclosure relates to a system where reconfiguration of a computer network does not require rebooting of the reconfigured computer network.

2. Background

1. References

The following U.S. patents and papers provide useful background information, for which they are incorporated herein by reference in their entirety.

a) Patents

| | | |
|---|---|---|
| 4,939,718 | July 1990 | Servel et al. |
| 5,146,454 | September 1992 | Courtois et al. |
| 5,612,949 | March 1997 | Bennett |
| 5,729,528 | March 1998 | Salingre et al. |

b) Other References

“Moving to Distributed Processing Standards: Remote Procedure Call”, http://www ja.net/documents/NetworkNews/Issue44/RPC.html

2. Introduction

A user typically accesses a file that is stored on a remote server, by sending a sequence of network packets from a client workstation to the remote server that actually stores the file. Specific information in the packets point to the file to be opened, and may further include information on the intended use of the file. Over time, various servers may develop significant imbalance versus other servers. This is because, files, or objects, cluster on a specific server but may be mostly used by a computer in another location. In other cases, a new additional server could have been added to the network system. In such a case, for efficient functioning, the load may have to be balanced between the newly added server and the pre-existing servers in the network.

There are at least four ways in which files manifest in the computer network. Each such manifestation could also be considered as objects that are different from each other. The basic form of manifestation is the actual data contained in the file itself. For example, in a document such actual data may be the text that is contained in that document. In addition to the actual data itself, there are meta data objects that are associated with the file constituting the three other ways of manifestation of the file. The meta data objects include: i) information about the file such as its associated permissions, statistics, and the like; ii) various mappings to the file, or otherwise ways of accessing the file; and iii) the name hierarchy for the file in the name space. It should be noted that the term “file” is used broadly to include, among others, a document, a document (or file) segment, a system snapshot, a control file, or otherwise any object accessible through the file system.

Initially, the decision where to physically store a file may be quite arbitrary. Usually, the file is stored close to where it was first created. Other selection criteria that have been conventionally used include, random, round robin, weighted round robin, least recently used, etc. However, over time, files may be required to be in other locations for more efficient use of system resources. This can be a result of adding a new server to the system or when more remotely located users need to access the file more frequently.

Conventional solutions do not handle relocation of objects efficiently. Efficiency becomes very important at least in cases of geographically distributed file systems or location independent file systems, and more specifically those having distributed cache systems. Static mapping is a conventionally used technique in which it is algorithmically challenging to re-map the hash tables that are used. Even if dynamic solution are used, in conventional pointer based file systems, synchronization is usually difficult and requires either rebooting the system or using extreme lock mechanisms to prevent damage to the functionality of the system.

To achieve a higher performance level in systems having the capability of reconfiguration without rebooting, it would be further advantageous if files could be relocated based on load measurements of the system.

### SUMMARY

To realize the advantages discussed above, the disclosed teachings provide a method for real-time reconfiguration of a computer network using load information from the computer network, the method comprises receiving remote procedure call (RPC) information by a server in the computer network. The RPC information is analyzed. Based on the analysis, it is determined whether a reconfiguration is required. If reconfiguration is required, one or more objects are relocated until reconfiguration is completed.

In another specific enhancement, the computer network is comprised of a plurality of servers.

More specifically said server that receives the RPC is one of said plurality of servers.

In another specific enhancement, said server is at least one of a host, storage node, a file-system, a location independent file system, and a geographically distributed computer system.

In another specific enhancement, said network is a distributed network.

In another specific enhancement, said network is one of a local area network (LAN) and wide area network (WAN).

In another specific enhancement, at least one of the objects is a file document, a file segment, a system snapshot or a control file.

In another specific enhancement, said RPC information comprises at least time related information, server related information, and queue related information.

More specifically, said time related information is at least one of start time, completion time and absolute clock time.

More specifically, said server related information is at least one of server's identification, server type and server capabilities.

Even more specifically, said queue related information is at least one of number of requests waiting for processing, number of requests processed in a given period of time, and average waiting time for processing.

In another specific enhancement, the analyzing is done periodically by the server.

In another specific enhancement, a load in a designated network path is detected by the analyzing.

More specifically, the analyzing detects a load in at least a queue of said plurality of servers.

More specifically, the determination for reconfiguration is done based on results of the analysis.

In another specific enhancement, the object is relocated using a sub-process comprising choosing a relocation server, updating said object's metadata, transferring said object to said relocation server, and updating a view identification (ID) table.

More specifically, said choosing relocation server is performed by considering at least one of: server load, latency, system load, new server.

Even more specifically, said object metadata comprises at least: object attribute, object path, object name hierarchy in the name space.

Even more specifically, said view ID table comprises at least information about: said object new location, said object current view-ID.

Even More specifically, updating said metadata comprises attaching a unique view identification (ID) to said object metadata.

Even more specifically, said view ID is a sequential number identifying the specific view of said object.

Another aspect of the disclosed teachings is a method for using remote procedure call (RPC) for gathering computer network load information, the method comprising attaching load information to an outbound RPC information corresponding to a request, the request being sent by a first server to a second server in the network. An inbound RPC information is received from the second server, the inbound RPC information being related to a response for the request. System load is determined from the inbound RPC information.

Specific enhancements to the above method are also provided.

Another aspect of the disclosed teachings is a computer program product including computer-readable media comprising instructions to enable a computer to implement the above method steps.

Another aspect of the disclosed teachings is a server in a computer network capable of providing reconfiguration information based on load information, the server comprises a processor and a communicator connected to said processor and further connected to the computer network. The processor is capable of determining system load based on system load measurements performed over said computer network.

Specific enhancement to the above server to make it capable of performing the method steps outlined above are also part of the disclosed teachings.

### BRIEF DESCRIPTION OF THE DRAWINGS

The above objectives and advantages of the disclosed teachings will become more apparent by describing in detail preferred embodiments thereof with reference to the attached drawings in which:

FIG. 1 is an exemplary diagram of a typical client-server architecture;

FIG. 2 is an exemplary RPC information format in accordance with the disclosed invention; and

FIG. 3 is an example of several RPC information flow steps.

### DETAILED DESCRIPTION

A typical architecture of a client-server environment 100 is shown is shown in FIG. 1. Clients 110 1-n and servers 120 1-m are each connected to network 130 making it possible for them to communicate with each other. A client, for example 110-1 may send a request to a server, for example 120-1, over network 130. Server 120-1 may receive multiple requests from multiple clients and typically processes them in the order of receipt, or in other cases according to a prioritization policy. Requests are queued in server 120-1 awaiting their turn to be processed by the server 120-1. Once processed by server 120-1, the response to the request is sent to client 110-1.

Network 130 may be a local area network (“LAN”), a wide area network (“WAN”) or other types of distributed networks. Specifically, the network may be capable of operating as a location independent file system where a client, for example 110-1, may be unaware where a respective file resides on servers 120 1-m. System 100 further operates using capabilities of real-time reconfiguration as described in the concurrently filed U.S. provisional patent application entitled “A Method and Computer Software for Real-Time Network Configuration”, filed on the same date as the present application, and which is assigned to the same common assignee as the present application, and is hereby incorporated herein by reference in its entirety for all it discloses. The same is also disclosed in the above-mentioned concurrently filed application.

A need may arise to perform reconfiguration of the network as a result of events affecting the system performance. These events may include adding a new server to the network, removing a server from the network, imbalance in overall loads over the network, imbalance of loads between a variety of servers in the network, higher then desired latency for write operations, overload in uninterruptible power supply (UPS) backed up memories, etc. It should be noted though that attempting to achieve precise load measurements is a costly approach that may result in degradation of overall system performance. It is therefore desirable to provide a system where measurements are precise enough to provide useful results but without hurting the system performance.

The disclosed techniques piggyback on conventional techniques of measurement, that data of which is sent in conjunction with remote procedure calls (RPC) which are used to send and receive information from servers. RPC is a set of rules for marshalling and unmarshalling parameters and results. RPC maybe used to perform the following activities, among others:

the activity that takes place at the point where the control path in the calling and called process enters or leaves the RPC domain;

a set of rules for encoding and decoding information transmitted between two processes;

a few primitive operations to invoke an individual call, to return its results, and to cancel it;

a provision in the operating system; and

process structure to maintain and reference state that is shared by the participating processes.

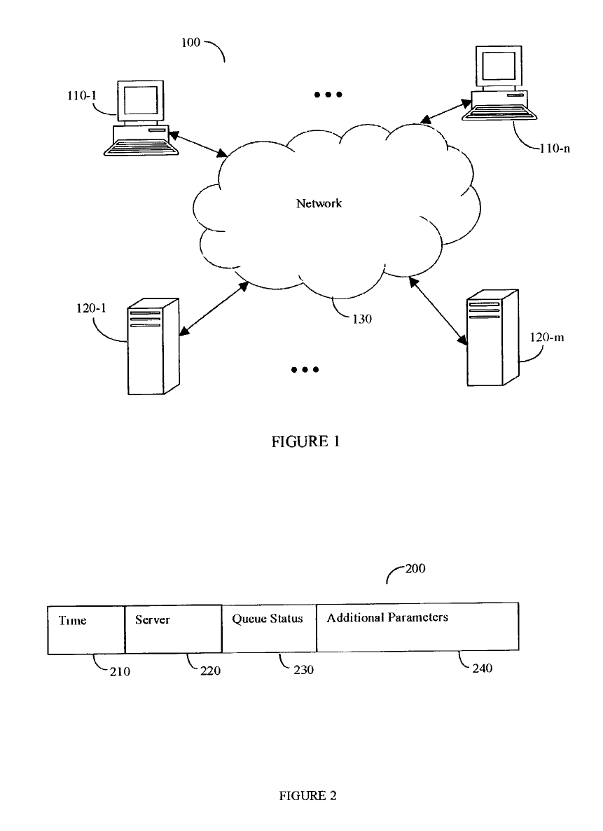

FIG. 2 shows an exemplary format 200 of the information piggybacked onto an RPC. The information format 200 may have one or more fields containing information to be used for the purposes further described below. Field 210 contains time-related information. This may include information such as start and completion time, absolute clock time, system time, etc. Field 220 may contain server-related information including information such as server's identification, server capabilities, server type, etc. Field 230 may contain information of the respective server queue, including the number of requests waiting for processing, the number of requests processed in a given period of time, the average wait time for processing, etc. A person skilled in the art can add additional information in the optional parameter field 240. All the information collected using the RPC delivery system may be later used for the purposes described in detail below.

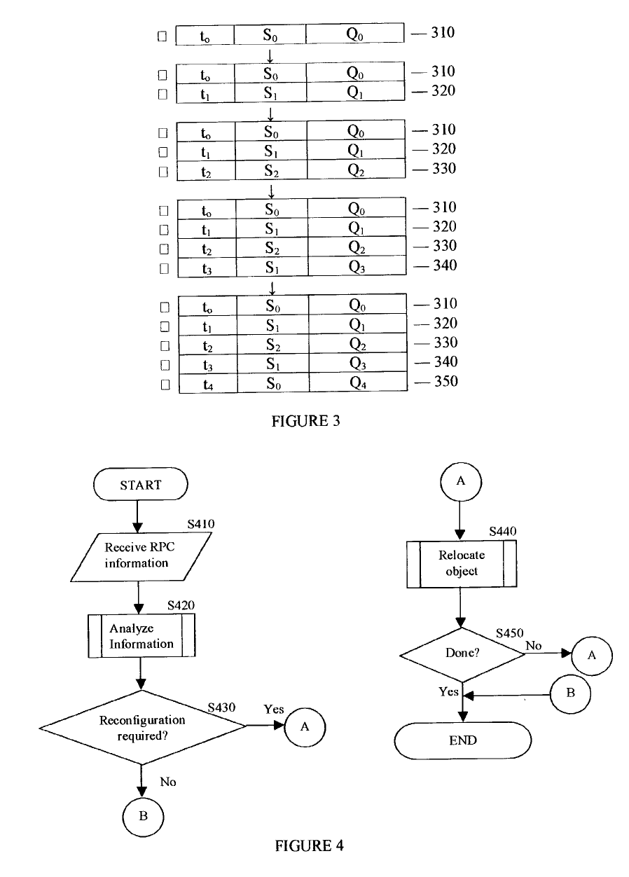

FIG. 3 shows an exemplary use of the RPC information as a step-by-step process. In step 1, a server S0 has processed a request. It is also shown that the queue for S0 is defined to be at a level of Q0 at time t0. As the processing continues at a different server, S1, RPC information 310 is sent to S1 from S0. Server S1 executes the associated processes in response to the received RPC. It then attaches its own RPC information 320 to the available RPC information 310 at step 2. Processing is now transferred to yet another server S2 which further attaches its own RPC information 330 at step 3. In this example, the server S2 returns to servers S1 and S0 in succession, each attaching their respective RPC information 340 and 350 during the return process.

It can be now easily seen that there is ample information at the receiving end to perform a variety of calculations based on the information gathered. From this information that is gathered various conclusions can be drawn. These conclusions can result in a decision to reconfigure the system for more efficient use. It should be noted, however, that unlike conventional systems where a precise system status is provided, in the disclosed technique the system status is non-precise. This is at least because, the conclusions with respect to the information do not relate to a full system status. The conclusions drawn are with respect to the path followed by the specific processing related to the request.

An exemplary use of the information that is gathered through this system is the ability to assess the load on each server. For example, the data related to server S1 might show that at time ti the queue level Q1 was significantly lower then the queue level Q3 of the same server at time t3. In such a case, it may be desirable to route requests through another server instead of continuing to load the already overloaded server S1. It is well-known that in a system containing multiple servers, e.g., a distributed network system, more than one server is capable of handling a task, for example the task handled by S1. Therefore, in accordance with the disclosed technique, and as further described below, it is possible to use such a similar server to execute the task thereby off loading the overloaded server.

FIG. 4 shows an exemplary flowchart of the process performed as a result of the receipt of the RPC information. At S410, the RPC information is received by the server. This information is then analyzed in S420. A more detailed description of the analysis is provided below. At S430, it is checked whether or not reconfiguration is required. If no reconfiguration is required, then the process terminates. If reconfiguration is required, then in S440, an object is relocated based on the analysis at S420. At S450, a check is performed to detect if all require relocations have been completed. If there are additional relocations to be performed then execution continues with S440 or otherwise, the process terminates. A detailed description of the step S440 may be found in the above-mentioned related U.S regular application and its corresponding provisional application.

The analysis in step S420 is performed periodically. Such an analysis is based on information gathered by use of the RPC process described above. Further, this information is also derived from multiple tasks. Based on the information gathered an information database is created. This database is used for the purpose of deciding whether or not reconfiguration of a system is required, and further, if a decision to reconfigure is made then what kind of reconfiguration should be performed.

For example, the analysis may reveal that using a first path using certain servers is slower then a second path that uses certain other servers. Therefore, the system may opt to use the second path in a higher priority.

In another example, the analysis may reveal that the queues related to one or more servers are overloaded compared to the queues related to other servers. It may the system then prefers to send new tasks to the less loaded servers. This may be done by allocating a higher probability of use to the less loaded servers compared to the more loaded servers. For example, a server with a less loaded queue may have twice the probability of being used compared to a more loaded server.

By using weighted probabilities, the system can spread loads more evenly throughout the system without completely stopping the use of some of the elements available. It is essential to continue to gather information from those servers and resume use of those servers when their load is reduced. An advantage of the disclosed technique is that no rebooting or other sophisticated locking mechanisms are required which would further result in a reduced system performance.

An aspect of the disclosed teachings is a computer program product including computer-readable media comprising instructions. The instructions are capable of enabling a computer to implement the methods described above. It should be noted that the computer-readable media could be any media from which a computer can receive instructions, including but not limited to hard disks, RAMs, ROMs, CDs, magnetic tape, internet downloads, carrier wave with signals, etc. Also instructions can be in any form including source code, object code, executable code, and in any language including higher level, assembly and machine languages.

The computer system is not limited to any type of computer. It could be implemented in a stand-alone machine or implemented in a distributed fashion, including over the internet.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A method for real-time reconfiguration of a computer network using load information from the computer network, the method comprising:
a) receiving remote procedure call (RPC) information by a server in the computer network;
b) analyzing said RPC information;
c) determining whether a reconfiguration is required based on the analysis of step b;
d) if reconfiguration is required, relocating one or more objects until reconfiguration is completed.

2. The method of claim 1, wherein said computer network is comprised of a plurality of servers.

3. The method of claim 2, wherein said server that receives the RPC is one of said plurality of servers.

4. The method of claim 1, wherein said server is at least one of a host, storage node, a file-system, a location independent file system, and a geographically distributed computer system.

5. The method of claim 5, wherein said network is a distributed network.

6. The method of claim 5, wherein said network is one of a local area network (LAN) and wide area network (WAN).

7. The method of claim 1, wherein at least one of the objects is a file document, a file segment, a system snapshot or a control file.

8. The method of claim 1, wherein said RPC information comprises at least time related information, server related information, and queue related information.

9. The method of claim 8, wherein said time related information is at least one of start time, completion time and absolute clock time.

10. The method of claim 8, wherein said server related information is at least one of server's identification, server type and server capabilities.

11. The method of claim 8, wherein said queue related information is at least one of number of requests waiting for processing, number of requests processed in a given period of time, and average waiting time for processing.

12. The method of claim 1, wherein the analyzing is done periodically by the server.

13. The method of claim 1, wherein a load in a designated network path is detected by the analyzing.

14. The method of claim 2, wherein the analyzing detects a load in at least a queue of said plurality of servers.

15. The method of claim 1, wherein the determination for reconfiguration is done based on results of the analysis.

16. The method of claim 1, wherein the object is relocated using a sub-process comprising:
d1) choosing a relocation server;
d2) updating said object's metadata;
d3) transferring said object to said relocation server; and
d4) updating a view identification (ID) table.

17. The method of claim 16, wherein said choosing relocation server is performed by considering at least one of: server load, latency, system load, new server.

18. The method of claim 16, wherein said object metadata comprises at least:
object attribute, object path, object name hierarchy in the name space.

19. The method of claim 16, wherein said view ID table comprises at least information about: said object new location, said object current view-ID.

20. The method of claim 16, wherein updating said metadata comprises attaching a unique view identification (ID) to said object metadata.

21. The method of claim 20, wherein said view ID is a sequential number identifying the specific view of said object.

22. A computer program product including computer-readable media, said media comprising instructions for enabling a computer to execute a procedure for real-time reconfiguration of a computer network using load information from the computer network, the procedure comprising:
a) receiving remote procedure call (RPC) information by a server in the computer network;
b) analyzing said RPC information;
c) determining whether a reconfiguration is required based on the analysis of step b; and
d) if reconfiguration is required, relocating one or more objects until reconfiguration is completed.

23. The computer program product of claim 22, wherein said computer network is comprised of a plurality of servers.

24. The computer program product of claim 23, wherein said server that receives the RPC is one of said plurality of servers.

25. The computer program product of claim 22, wherein said server is at least one of a host, storage node, a file-system, a location independent file system, and a geographically distributed computer system.

26. The computer program product of claim 22, wherein said network is a distributed network.

27. The computer program product of claim 26, wherein said network is one of a local area network (LAN) and wide area network (WAN).

28. The computer program product of claim 22, wherein at least one of the objects is a file document, a file segment, a system snapshot or a control file.

29. The computer program product of claim 22, wherein said RPC information comprises at least time related information, server related information, and queue related information.

30. The computer program product of claim 29, wherein said time related information is at least one of start time, completion time and absolute clock time.

31. The computer program product of claim 29, wherein said server related information is at least one of server's identification, server type and server capabilities.

32. The computer program product of claim 29, wherein said queue related information is at least one of number of requests waiting for processing, number of requests processed in a given period of time, and average waiting time for processing.

33. The computer program product of claim 22, wherein the analyzing is done periodically by the server.

34. The computer program product of claim 22, wherein a load in a designated network path is detected by the analyzing.

35. The computer program product of claim 23, wherein the analyzing detects a load in at least a queue of said plurality of servers.

36. The computer program product of claim 22, wherein the determination for reconfiguration is done based on results of the analysis.

37. The computer program product of claim 22, wherein the object is relocated using a sub-process comprising:
d1) choosing a relocation server;
d2) updating said object's metadata;
d3) transferring said object to said relocation server; and
d4) updating a view identification (If)) table.

38. The computer program product of claim 37, wherein said choosing relocation server is performed by considering at least one of: server load, latency, system load, new server.

39. The computer program product of claim 37, wherein said object metadata comprises at least: object attribute, object path, object name hierarchy in the name space.

40. The computer program product of claim 37, wherein said view ID table comprises at least information about: said object new location, said object current view-ID.

41. The computer program product of claim 37, wherein updating said metadata comprises attaching a unique view identification (ID) to said object metadata.

42. The computer program product of claim 41, wherein said view ID is a sequential number identifying the specific view of said object.

43. A method for using remote procedure call (RPC) for gathering computer network load information, the method comprising:
a) attaching load information to an outbound RPC information corresponding to a request, the request being sent by a first server to a second server in the network;
b) receiving an inbound RPC information from the second server, the inbound RPC information being related to a response for the request; and
c) determining system load from the inbound RPC information.

44. The method of claim 43, wherein said computer network is comprised of a plurality of servers.

45. The method of claim 43, wherein said first server and said second server are part of said plurality of servers.

46. The method of claim 43, wherein said computer network is a distributed network.

47. The method of claim 46, wherein said network is one of a local area network (LAN) and wide area network (WAN).

48. The method of claim 43, wherein said RPC information comprises at least time related information, server related information and queue related information.

49. The method of claim 48, wherein said time related information is at least one of start time, completion time, absolute clock time.

50. The method of claim 48, wherein said server related information is at least one of server's identification, server type and server capabilities.

51. The method of claim 48, wherein said queue related information is at least one of number of requests waiting for processing, number of requests processed in a given period of time, average wait time for processing.

52. The method of claim 43, wherein said determining system load is intended for balancing loads on at least one server connected to said computer network.

53. A computer program product including computer-readable media, said media comprising instructions for enabling a computer to execute a procedure for using remote procedure call (RPC) for gathering computer network load information, the procedure comprising:
a) attaching load information to an outbound RPC information corresponding to a request, the request being sent by a first server to a second server in the network;
b) receiving an inbound RPC information from the second server, the inbound RPC information being related to a response for the request; and
c) determining system load from the inbound RPC information.

54. The computer program product of claim 53, wherein said computer network is comprised of a plurality of servers.

55. The computer program product of claim 53, wherein said first server and said second server are part of said plurality of servers.

56. The computer program product of claim 53, wherein said computer network is a distributed network.

57. The computer program product of claim 56, wherein said network is one of a local area network (LAN) and wide area network (WAN).

58. The computer program product of claim 53, wherein said RPC information comprises at least time related information, server related information and queue related information.

59. The computer program product of claim 58, wherein said time related information is at least one of start time, completion time, absolute clock time.

60. The computer program product of claim 58, wherein said server related information is at least one of server's identification, server type and server capabilities.

61. The computer program product of claim 58, wherein said queue related information is at least one of number of requests waiting for processing, number of requests processed in a given period of time, average wait time for processing.

62. The computer program product of claim 53, wherein said determining system load is intended for balancing loads on at least one server connected to said computer network.

63. A server in a computer network capable of providing reconfiguration information based on load information, the server comprising:
a processor;
a communicator connected to said processor and further connected to the computer network;
said processor capable of determining system load based on system load measurements performed over said computer network.

64. The server of claim 63, wherein said computer network is comprised of a plurality of servers connected by the communicator.

65. The server of claim 64, wherein said server is at least one of a host, storage node, file-system, location independent file system, geographically distributed computer system.

66. The server of claim 64, wherein said network is a distributed network.

67. The server of claim 66, wherein said distributed network is one of a local area network (LAN) and a wide area network (WAN).

68. The server of claim 63, wherein said server is further capable of performing real-time reconfiguration based on at least said load information.

69. The server of claim 68, wherein said server is capable of receiving remote procedure call (RPC) information by said server, analyzing said RPC information; determining whether a reconfiguration is required and if so relocating objects till reconfiguration is completed.

70. The server of claim 69, wherein the processor is further capable of handling said RPC.

71. The server of claim 69, wherein the processor is capable of receiving the RPC information.

72. The server of claim 63, wherein the server is capable of attaching load information to an outbound RPC information corresponding to a request, the request being sent by a first server to a second server in the network, the processor is further capable of receiving an inbound RPC information from the second server, the inbound RPC information being related to a response for the request, and the processor is still further capable of determining system load from the inbound RPC information.

73. The server of claim 72, wherein said RPC information comprises at least time related information, server related information, queue related information.

74. The server of claim 72, wherein said time related information is at least one of start time, completion time, absolute clock time.

75. The server of claim 72, wherein said queue related information is at least one of number of requests waiting for processing, number of requests processed in a given period of time, average wait time for processing.
